(19) United States
(12) Patent Application Publication
(10) Pub. No.: US 2024/0305425 A1
(43) Pub. Date: Sep. 12, 2024

(54) METHODS AND DEVICES ON TRANSMIT AND RECEIVE PERFORMANCE FOR TIME SYNCHRONIZATION

(71) Applicant: Telefonaktiebolaget LM Ericsson (Publ), Stockholm (SE)

(72) Inventors: Zhipeng Lin, Nanjing (CN); Zhenhua Zou, Solna (SE); Yufei Blankenship, Kildeer, IL (US)

(21) Appl. No.: 18/551,999

(22) PCT Filed: Apr. 4, 2022
(86) PCT No.: PCT/IB2022/053122

§ 371 Date: Sep. 22, 2023

(30) Foreign Application Priority Data
Apr. 2, 2021 (WO) PCT/CN2021/085461

(51) Int. Cl. H04L 5/00; H04B 17/309; H04L 27/26

(52) U.S. Cl. CPC H04L 5/0051; H04B 17/346; H04L 5/0078; H04L 27/26025

(57) ABSTRACT

Systems and methods are disclosed for enhanced transmit and receive performance for time synchronization. In one embodiment, a method performed by an access node for a wireless network comprises receiving a Physical Random Access Channel (PRACH) preamble from a User Equipment (UE) and deriving timing-related information based on the PRACH preamble in accordance with a defined uplink signal timing detection error requirement, the defined uplink signal timing detection error requirement being stricter than a respective uplink signal timing detection error requirement defined in Release 15 and 16 of Third Generation Partnership Project New Radio (NR) specifications for a subcarrier spacing used for the PRACH preamble. The method further comprises sending the timing-related information to the UE. In this manner, enhanced time synchronization performance can be achieved.

### RELATED APPLICATIONS

This application claims the benefit of provisional patent application serial number PCT/CN2021/085461, filed Apr. 2, 2021, the disclosure of which is hereby incorporated herein by reference in its entirety.

### TECHNICAL FIELD

The present disclosure generally relates to the field of time synchronization, and more particularly to methods and devices on transmit and receive performance for time synchronization in Physical Random Access Channel (PRACH) transmission.

### BACKGROUND

This section introduces aspects that may facilitate better understanding of the present disclosure. Accordingly, the statements of this section are to be read in this light and are not to be understood as admissions about what is in the prior art or what is not in the prior art.

### Time Sensitive Network for IIOT in NR

For supporting Time Sensitive Network (TSN) time synchronization, the Third Generation Partnership Project (3GPP) Fifth Generation System (5GS) is integrated with the external network as a TSN bridge (or time-aware system). There are two synchronization systems under consideration: 5GS synchronization and TSN domain synchronization. The 5GS synchronization is specified in 3GPP specifications for Next Generation (NG) Radio Access Network (RAN) synchronization, while the TSN domain synchronization follows Institute of Electronics and Electrical Engineers (IEEE) 802.1AS and provides synchronization service to the TSN.

The 5GS time synchronization needs to satisfy stringent accuracy requirements in order to support inter-working with a TSN. A demanding use case in the context of TSN-5GS interworking is when TSN Grandmaster clocks are located at end stations connected to User Equipment (UE)/Device-Side TSN Translators (DS-TTs). This new Release 17 use case involves two Uu interfaces in the 5GS path (i.e., 5GS ingress to 5GS egress) over which a TSN Grandmaster clock is relayed. One variant of the use case is illustrated in FIG. 1, which shows TSN end-to-end timing delivery where the ingress is at UE1, wherein two UEs may be connected to different next generation NodeBs (gNBs), thereby introducing the potential for increased uncertainty compared to the case where the two UEs are both connected to the same gNB.

The 5GS synchronicity budget is the portion of the end-to-end synchronicity budget applicable between the ingress and egress of the 5GS, as shown in FIG. 1. The per Uu interface synchronization error represents a portion of the end-to-end synchronicity budget and consists of the uncertainty introduced when (a) sending the Fifth Generation (5G) reference time from the gNB antenna to the UE antenna by including ReferenceTimeInfo in either a DLInformationTransfer Radio Resource Control (RRC) message or System Information Block (SIB) 9 (SIB9) and then (b) adjusting the 5G reference time to reflect the downlink propagation delay.

The range of uncertainty for a single Uu interface shown in Table 1 below was agreed at 3GPP TSG-RAN WG2 #113-e.

TABLE 1
Range of Uncertainty for a Single Uu interface

| Scenario | Single Uu interface Budget |
|---|---|
| Control-to-Control | ±145 ns to ±275 ns |
| Smart Grid | ±795 ns to ±845 ns |

The Release 17 RAN work item “Enhanced Industrial Internet of Things (IoT) and ultra-reliable and low latency communication (URLLC) support for NR” has the following objective, where propagation delay compensation is used to achieve time synchronization between the UE and its associated gNB:
5. Enhancements for support of time synchronization:
   a. RAN impacts of SA2 work on uplink time synchronization for TSN, if any. [RAN2]
   b. Propagation delay compensation enhancements (including mobility issues, if any). [RAN2, RAN1, RAN3, RAN4]

As agree by RAN1 in RAN1 #102e:
The following options for propagation delay compensation are further studied in RAN1
   Option 1: TA-based propagation delay
      Option 1a: Propagation delay estimation based on legacy Timing advance (potentially with enhanced TA indication granularity).
      Option 1b: Propagation delay estimation based on timing advanced enhanced for time synchronization (similar to 1a but with updated RAN4 requirements to TA adjustment error and Te)
      Option 1c: Propagation delay estimation based on a new dedicated signaling with finer delay compensation granularity (Separated signaling from TA so that TA procedure is not affected)
   Option 2: RTT based delay compensation:
      Propagation delay estimation based on an RAN managed Rx-Tx procedure intended for time synchronization (FFS to expand or separate procedure/signaling to positioning).

### TA-Based Propagation Delay Compensation

The Timing Advance (TA) command is utilized in cellular communication for uplink transmission synchronization. It is further classified as two types:
1. In the beginning, at connection setup, an absolute timing parameter is communicated to a UE using the Medium Access Control (MAC) Random Access Response (RAR) element.
2. After connection setup, a relative timing correction can be sent to a UE using MAC Control Element (CE) (e.g., UEs can move or due to multi-path because of changing environment).

The downlink Propagation Delay (PD) can be estimated for a given UE by (a) first summing the TA value indicated by the RAR and all subsequent TA values sent using the MAC CE and (b) taking some portion of the total TA value resulting from summation of all the TA values (e.g., 50% could be used assuming the downlink and uplink propagation delays are essentially the same). The PD can be utilized to understand time synchronization dynamics, e.g., accurately tracking the value of a clock at UE side relative to the value of that clock in another network node.

### RTT-Based Propagation Delay Compensation

For the Round-Trip Time (RTT) based method, the UE Receive-Transmit (Rx-Tx) Time Difference and/or gNB Rx-Tx Time Difference are measured at the UE side and the gNB side, respectively, and then used to derive the propagation delay.

For instance, two types of Timing Advance (TADV) can be defined:

$$Type 1 : TADV = ( gNB Rx - Tx time difference ) + ( UE Rx - Tx time difference ) ;$$

$$Type 2 : TEDV = gNB Rx - Tx time difference .$$

With either Type 1 or Type 2, the propagation delay can be estimated as ½*TADV.

For Type 2 TADV, the Rx-Tx time difference corresponds to a received uplink radio frame containing a Physical Random Access Channel (PRACH) from the respective UE.

### UL Time Synchronization in New Radio (NR)

In RRC_CONNECTED, the gNB is responsible for maintaining the timing advance to keep the L1 synchronized. Serving cells having uplink (UL) to which the same timing advance applies and using the same timing reference cell are grouped in a Timing Advance Group (TAG). Each TAG contains at least one serving cell with configured uplink, and the mapping of each serving cell to a TAG is configured by RRC.

For the primary TAG, the UE uses the Primary Cell (PCell) as a timing reference, except with shared spectrum channel access where a Secondary Cell (SCell) can also be used in certain cases (see clause 7.1 of 3GPP Technical Specification (TS) 38.133 V17.0.0). In a secondary TAG, the UE may use any of the activated SCells of this TAG as a timing reference cell but should not change it unless necessary.

Timing advance updates are signaled by the gNB to the UE via MAC CE commands. Such commands restart a TAG-specific timer which indicates whether the Layer 1 (L1) can be synchronized or not. When the timer is running, the L1 is considered synchronized; otherwise, the L1 is considered non-synchronized in which case uplink transmission can only take place on a PRACH.

The TA timer is configured in TAG-Config Information Element (IE) in the IE MAC-CellGroupConfig which is used to configure MAC parameters for a cell group, including DRX. The TAG-Config IE is currently defined as:

-- ASN1START
-- TAG-TAG-CONFIG-START

| | |
|---|---|
| TAG-Config ::= | SEQUENCE { |
| tag-ToReleaseList | SEQUENCE (SIZE (1..maxNrofTAGs)) OF TAG-Id |

OPTIONAL, -- Need N

| | |
|---|---|
| tag-ToAddModList | SEQUENCE (SIZE (1..maxNrofTAGs)) OF TAG |

OPTIONAL -- Need N
}

| | |
|---|---|
| TAG ::= | SEQUENCE { |
| tag-Id | TAG-Id, |
| timeAlignmentTimer | TimeAlignmentTimer, |

...
}

| | |
|---|---|
| TimeAlignmentTimer ::= | ENUMERATED {ms500, ms750, ms1280, ms1920, |

ms2560, ms5120, ms10240, infinity}
-- TAG-TAG-CONFIG-STOP
-- ASN1STOP

TAG field descriptions

tag-Id
Indicates the TAG of the SpCell or an SCell. Uniquely identifies
the TAG within the scope of a Cell Group (i.e. MCG or SCG).
timeAlignmentTimer
Value in ms of the timeAlignmentTimer for TAG with ID tag-Id.

### Timing Estimation Error at gNB

PRACH timing detection error tolerance (see 3GPP TS 38.104 V17.1.0) in NR is described in the following excerpt from 3GPP TS 38.104:

### ***** START EXCERPT FROM 3GPP TS 38.104 ****

### 8.4.2 PRACH Detection Requirements

### 8.4.2.1 General

The probability of detection is the conditional probability of correct detection of the preamble when the signal is present. There are several error cases-detecting different preamble than the one that was sent, not detecting a preamble at all or correct preamble detection but with the wrong timing estimation. For AWGN and TDLC300-100, a timing estimation error occurs if the estimation error of the timing of the strongest path is larger than the time error tolerance given in Table 8.4.2.1-1. The performance requirements for high speed train (table 8.4.23-1 to 8.4.2.3-4) are optional.

TABLE 8.4.2.1-1
Time error tolerance for AWGN and TDLC300-100

| PRACH | PRACH SCS | Time error tolerance | |
|---|---|---|---|
| preamble | (kHz) | AWGN | TDLC300-100 |
| 0 | 1.25 | 1.04 us | 2.55 us |
| A1, A2, A3, B4, | 15 | 0.52 us | 2.03 us |
| C0, C2 | 30 | 0.26 us | 1.77 us |

### 11.4.2.2 PRACH Detection Requirements

### 11.4.2.2.1 General

The probability of detection is the conditional probability of correct detection of the preamble when the signal is present. There are several error cases-detecting different preamble than the one that was sent, not detecting a preamble at all or correct preamble detection but with the wrong timing estimation. For AWGN and TDLA30-300, a timing estimation error occurs if the estimation error of the timing of the strongest path is larger than the time error tolerance given in Table 11.4.2.2-1.

TABLE 11.4.2.2-1
Time error tolerance for AWGN and TDLA30-300

| PRACH | PRACH SCS | Time error tolerance | |
|---|---|---|---|
| preamble | (kHz) | AWGN | TDLA30-300 |
| A1, A2, A3, B4, | 60 | 0.13 us | 0.28 us |
| C0, C2 | 120 | 0.07 us | 0.22 us |

### ***** END EXCERPT FROM 3GPP TS 38.104 *****

### UE Rx-Tx Time Difference

The UE Rx-Tx time difference is defined as T_{UE-RX}−T_{UE-TX} where T_{UE-RX} is the UE received timing of downlink subframe #i from a Transmission Point (TP), defined by the first detected path in time, and T_{UE-TX} is the UE transmit timing of uplink subframe #j that is closest in time to the subframe #i received from the TP. Multiple DL Positioning Reference Signal (PRS) resources can be used to determine the start of one subframe of the first arrival path of the TP. For frequency range 1, the reference point for T_{UE-RX} measurement shall be the Rx antenna connector of the UE and the reference point for T_{UE-TX} measurement shall be the Tx antenna connector of the UE. For frequency range 2, the reference point for T_{UE-RX} measurement shall be the Rx antenna of the UE and the reference point for T_{UE-TX} measurement shall be the Tx antenna of the UE. The UE Rx-Tx time difference is applicable for RRC_CONNECTED.

The gNB Rx-Tx time difference is defined as T_{gNB-RX}−T_{gNB-TX} where T_{gNB-RX} is the Transmission and Reception Point (TRP) received timing of uplink subframe #i containing Sounding Reference Signal (SRS) associated with UE, defined by the first detected path in time, and T_{gNB-TX} is the TRP transmit timing of downlink subframe #j that is closest in time to the subframe #i received from the UE. Multiple SRS resources for positioning can be used to determine the start of one subframe containing SRS. The reference point for T_{gNB-RX} shall be:
for type 1-C base station TS 38.104 the Rx antenna connector,
for type 1-O or 2-O base station TS 38.104: the Rx antenna (i.e., the center location of the radiating region of the Rx antenna),
for type 1-H base station TS 38.104: the Rx Transceiver Array Boundary connector.
   The reference point for TgNB-TX shall be:
for type 1-C base station TS 38.104: the Tx antenna connector,
for type 1-O or 2-O base station TS 38.104: the Tx antenna (i.e., the center location of the radiating region of the Tx antenna),
for type 1-H base station TS 38.104: the Tx Transceiver Array Boundary connector.

### SUMMARY

Systems and methods are disclosed for enhanced transmit and receive performance for time synchronization. In one embodiment, a method performed by an access node for a wireless network comprises receiving a Physical Random Access Channel (PRACH) preamble from a User Equipment (UE) and deriving timing-related information based on the PRACH preamble in accordance with a defined uplink signal timing detection error requirement, the defined uplink signal timing detection error requirement being stricter than a respective uplink signal timing detection error requirement defined in Release 15 and 16 of Third Generation Partnership Project (3GPP) New Radio (NR) specifications for a subcarrier spacing used for the PRACH preamble. The method further comprises sending the timing-related information to the UE. In this manner, enhanced time synchronization performance can be achieved.

In one embodiment, the subcarrier spacing used for the PRACH preamble is 15 kilohertz, and the defined uplink signal timing detection error requirement is less than 0.52 microseconds for an Additive White Gaussian Noise (AWGN) channel or less than 2.03 microseconds for a TDLC300-100 channel.

In one embodiment, the subcarrier spacing used for the PRACH preamble is 30 kilohertz, and the defined uplink signal timing detection error requirement is less than 0.26 microseconds for an AWGN channel or less than 1.77 microseconds for a TDLC300-100 channel.

In one embodiment, the subcarrier spacing used for the PRACH preamble is 60 kilohertz, and the defined uplink signal timing detection error requirement is less than 0.13 microseconds for an AWGN channel or less than 0.28 microseconds for a TDLC300-100 channel.

In one embodiment, the subcarrier spacing used for the PRACH preamble is 120 kilohertz, and the defined uplink signal timing detection error requirement is less than 0.07 microseconds for an AWGN channel or less than 0.22 microseconds for a TDLC300-100 channel.

In one embodiment, the subcarrier spacing used for the PRACH preamble is 15 kilohertz, and the defined uplink signal timing detection error requirement is 0.10 microseconds for an AWGN channel or 0.15 microseconds for a TDLC300-100 channel.

In one embodiment, the subcarrier spacing used for the PRACH preamble is 30 kilohertz, and the defined uplink signal timing detection error requirement is 0.05 microseconds for an AWGN channel or 0.10 microseconds for a TDLC300-100 channel.

In one embodiment, the subcarrier spacing used for the PRACH preamble is 15 kilohertz, and the defined uplink signal timing detection error requirement is 0.05 microseconds for an AWGN channel or 0.10 microseconds for a TDLC300-100 channel.

In one embodiment, the subcarrier spacing used for the PRACH preamble is 30 kilohertz, and the defined uplink signal timing detection error requirement is 0.03 microseconds for an AWGN channel or 0.05 microseconds for a TDLC300-100 channel.

In one embodiment, the subcarrier spacing used for the PRACH preamble is 60 kilohertz, and the defined uplink signal timing detection error requirement is 0.06 microseconds for an AWGN channel or 0.14 microseconds for a TDLC300-100 channel.

In one embodiment, the subcarrier spacing used for the PRACH preamble is 120 kilohertz, and the defined uplink signal timing detection error requirement is 0.03 microseconds for an AWGN channel or 0.11 microseconds for a TDLC300-100 channel.

In one embodiment, the defined uplink signal timing detection error requirement is a function of one or more capabilities of the access node, one or more capabilities of the UE, or both one or more capabilities of the access node and one or more capabilities of the UE.

In one embodiment, the timing-related information comprises a timing advance value for the UE.

Corresponding embodiments of an access node are also disclosed. In one embodiment, an access node for a wireless network is adapted to receive a PRACH preamble from a UE and derive timing-related information based on the PRACH preamble in accordance with a defined uplink signal timing detection error requirement, the defined uplink signal timing detection error requirement being stricter than a respective uplink signal timing detection error requirement defined in Release 15 and 16 of 3GPP NR specifications for a subcarrier spacing used for the PRACH preamble. The access node is further adapted to send the timing-related information to the UE.

In another embodiment, an access node for a wireless network comprises one or more processors and memory comprising instructions executable by the one or more processors whereby the access node is operable to receive a PRACH preamble from a UE, derive timing-related information based on the PRACH preamble in accordance with a defined uplink signal timing detection error requirement, the defined uplink signal timing detection error requirement being stricter than a respective uplink signal timing detection error requirement defined in Release 15 and 16 of 3GPP NR specifications for a subcarrier spacing used for the PRACH preamble, and send the timing-related information to the UE.

In another embodiment, a method performed by an access node for a wireless network comprises receiving an uplink reference signal from a UE and deriving timing-related information based on the uplink reference signal in accordance with a defined uplink signal timing detection error requirement, the defined uplink signal timing detection error requirement being a function of: a subcarrier spacing used for the uplink reference signal such that the uplink signal timing detection error requirement is inversely related to the subcarrier spacing used for the uplink reference signal; or a total bandwidth occupied by the uplink reference signal such that the uplink signal timing detection error requirement is inversely related to the total bandwidth occupied by the uplink reference signal; or both the subcarrier spacing used for the uplink reference signal and the total bandwidth occupied by the uplink reference signal. The method further comprises sending the timing-related information to the UE.

In one embodiment, the uplink reference signal is a Sounding Reference Signal (SRS).

In one embodiment, the subcarrier spacing used for the PRACH preamble is 15 kilohertz, the total bandwidth occupied by the uplink reference signal is between 10 Megahertz (MHz) and 20 MHZ, and the defined uplink signal timing detection error requirement is less than 0.20 microseconds for an AWGN channel or less than 0.30 microseconds for a TDLC300-100 channel.

In one embodiment, the subcarrier spacing used for the PRACH preamble is 15 kilohertz, the total bandwidth occupied by the uplink reference signal is between 20 MHz and 40 MHZ, and the defined uplink signal timing detection error requirement is less than 0.10 microseconds for an AWGN channel or less than 0.15 microseconds for a TDLC300-100 channel.

In one embodiment, the subcarrier spacing used for the PRACH preamble is 15 kilohertz, the total bandwidth occupied by the uplink reference signal is greater than or equal to 40 MHZ, and the defined uplink signal timing detection error requirement is less than 0.05 microseconds for an AWGN channel or less than 0.10 microseconds for a TDLC300-100 channel.

In one embodiment, the subcarrier spacing used for the PRACH preamble is 30 kilohertz, the total bandwidth occupied by the uplink reference signal is between 10 MHz and 20 MHZ, and the defined uplink signal timing detection error requirement is less than 0.20 microseconds for an AWGN channel or less than 0.30 microseconds for a TDLC300-100 channel.

In one embodiment, the subcarrier spacing used for the PRACH preamble is 30 kilohertz, the total bandwidth occupied by the uplink reference signal is between 20 MHz and 40 MHz, and the defined uplink signal timing detection error requirement is less than 0.10 microseconds for an AWGN channel or less than 0.15 microseconds for a TDLC300-100 channel.

In one embodiment, the subcarrier spacing used for the PRACH preamble is 30 kilohertz, the total bandwidth occupied by the uplink reference signal is greater than or equal to 40 MHZ, and the defined uplink signal timing detection error requirement is less than 0.05 microseconds for an AWGN channel or less than 0.10 microseconds for a TDLC300-100 channel.

In one embodiment, the subcarrier spacing used for the PRACH preamble is 60 kilohertz, the total bandwidth occupied by the uplink reference signal is between 10 MHz and 20 MHz, and the defined uplink signal timing detection error requirement is less than 0.20 microseconds for an AWGN channel or less than 0.30 microseconds for a TDLC300-100 channel.

In one embodiment, the subcarrier spacing used for the PRACH preamble is 60 kilohertz, the total bandwidth occupied by the uplink reference signal is between 20 MHz and 40 MHZ, and the defined uplink signal timing detection error requirement is less than 0.10 microseconds for an AWGN channel or less than 0.15 microseconds for a TDLC300-100 channel.

In one embodiment, the subcarrier spacing used for the PRACH preamble is 60 kilohertz, the total bandwidth occupied by the uplink reference signal is greater than or equal to 40 MHZ, and the defined uplink signal timing detection error requirement is less than 0.05 microseconds for an AWGN channel or less than 0.10 microseconds for a TDLC300-100 channel.

In one embodiment, the subcarrier spacing used for the PRACH preamble is 60 kilohertz, the total bandwidth occupied by the uplink reference signal is between 50 MHz and 100 MHz, and the defined uplink signal timing detection error requirement is less than 0.04 microseconds for an AWGN channel or less than 0.10 microseconds for a TDLC30-300 channel.

In one embodiment, the subcarrier spacing used for the PRACH preamble is 60 kilohertz, the total bandwidth occupied by the uplink reference signal is greater than or equal to 100 MHZ, and the defined uplink signal timing detection error requirement is less than 0.02 microseconds for an AWGN channel or less than 0.05 microseconds for a TDLC30-300 channel.

In one embodiment, the subcarrier spacing used for the PRACH preamble is 120 kilohertz, the total bandwidth occupied by the uplink reference signal is between 50 MHz and 100 MHz, and the defined uplink signal timing detection error requirement is less than 0.04 microseconds for an AWGN channel or less than 0.10 microseconds for a TDLC30-300 channel.

In one embodiment, the subcarrier spacing used for the PRACH preamble is 120 kilohertz, the total bandwidth occupied by the uplink reference signal is greater than or equal to 100 MHZ, and the defined uplink signal timing detection error requirement is less than 0.02 microseconds for an AWGN channel or less than 0.05 microseconds for a TDLC30-300 channel.

In one embodiment, the defined uplink signal timing detection error requirement is further based on one or more capabilities of the access node, one or more capabilities of the UE, or both one or more capabilities of the access node and one or more capabilities of the UE.

Corresponding embodiments of an access node are also disclosed. In one embodiment, an access node for a wireless network is adapted to receive an uplink reference signal from a UE and derive timing-related information based on the uplink reference signal in accordance with a defined uplink signal timing detection error requirement, the defined uplink signal timing detection error requirement being a function of: a subcarrier spacing used for the uplink reference signal such that the uplink signal timing detection error requirement is inversely related to the subcarrier spacing used for the uplink reference signal; or a total bandwidth occupied by the uplink reference signal such that the uplink signal timing detection error requirement is inversely related to the total bandwidth occupied by the uplink reference signal; or both the subcarrier spacing used for the uplink reference signal and the total bandwidth occupied by the uplink reference signal. The access node is further adapted to send the timing-related information to the UE.

In another embodiment, an access node for a wireless network comprises one or more processors and memory comprising instructions executable by the one or more processors whereby the access node is operable to receive an uplink reference signal from a UE and derive timing-related information based on the uplink reference signal in accordance with a defined uplink signal timing detection error requirement, the defined uplink signal timing detection error requirement being a function of: a subcarrier spacing used for the uplink reference signal such that the uplink signal timing detection error requirement is inversely related to the subcarrier spacing used for the uplink reference signal; or a total bandwidth occupied by the uplink reference signal such that the uplink signal timing detection error requirement is inversely related to the total bandwidth occupied by the uplink reference signal; or both the subcarrier spacing used for the uplink reference signal and the total bandwidth occupied by the uplink reference signal, and send the timing-related information to the UE.

In another embodiment, a method performed by an access node for a wireless network comprises measuring a receive timing of an uplink subframe containing an uplink signal associated with a UE, measuring a transmit timing of a downlink subframe that is closest in time to the uplink subframe containing the uplink signal associated with the UE, and deriving Receive-to-Transmit (Rx-Tx) timing of the access node based on the measured receive timing and the measured transmit timing. The Rx-Tx timing is derived in accordance with a defined Rx-Tx timing accuracy requirement that is a function of: (a) uplink signal Signal to Interference Plus Noise, SINR, Ês/Iot, where Ês is Received energy per Resource Element (RE) and Iot is a received power spectral density of a total noise and interference for a certain RE; (b) uplink signal Io range, where Io is a total received power density, including signal and interference, as measured at a UE antenna connector of the UE; (c) uplink signal transmission bandwidth; (d) uplink signal subcarrier spacing; (e) downlink signal subcarrier spacing; (f) whether Frequency Division Duplexing, FDD, or Time Domain Duplexing, TDD, is used; (g) whether the access node is operating in frequency range 1, FR1, or frequency range 2, FR2; (h) an operating band of the access node; (i) an operating band combination being used; (j) a configured maximum transmission power of the UE; (k) a configured maximum transmission power of the UE on a serving cell of the UE; or (l) any two or more of (a)-(k).

In one embodiment, the uplink signal is a PRACH preamble, a PUCCH signal, a PUSCH signal, a SRS, a DMRS, or a PTRS.

Corresponding embodiments of an access node are also disclosed. In one embodiment, an access node for a wireless network is adapted to measure a receive timing of an uplink subframe containing an uplink signal associated with a UE, measure a transmit timing of a downlink subframe that is closest in time to the uplink subframe containing the uplink signal associated with the UE, and derive Rx-Tx timing of the access node based on the measured receive timing and the measured transmit timing. The Rx-Tx timing is derived in accordance with a defined Rx-Tx timing accuracy requirement that is a function of: (a) uplink signal Signal to Interference Plus Noise, SINR, Ês/Iot, where Ês is Received energy per Resource Element (RE) and Iot is a received power spectral density of a total noise and interference for a certain RE; (b) uplink signal Io range, where Io is a total received power density, including signal and interference, as measured at a UE antenna connector of the UE; (c) uplink signal transmission bandwidth; (d) uplink signal subcarrier spacing; (e) downlink signal subcarrier spacing; (f) whether Frequency Division Duplexing, FDD, or Time Domain Duplexing, TDD, is used; (g) whether the access node is operating in frequency range 1, FR1, or frequency range 2, FR2; (h) an operating band of the access node; (i) an operating band combination being used; (j) a configured maximum transmission power of the UE; (k) a configured maximum transmission power of the UE on a serving cell of the UE; or (l) any two or more of (a)-(k).

In one embodiment, an access node for a wireless network comprises one or more processors and memory comprising instructions executable by the one or more processors whereby the access node is operable to measure a receive timing of an uplink subframe containing an uplink signal associated with a UE, measure a transmit timing of a downlink subframe that is closest in time to the uplink subframe containing the uplink signal associated with the UE, and derive Rx-Tx timing of the access node based on the measured receive timing and the measured transmit timing. The Rx-Tx timing is derived in accordance with a defined Rx-Tx timing accuracy requirement that is a function of: (a) uplink signal Signal to Interference Plus Noise, SINR, Ês/Iot, where Ês is Received energy per Resource Element (RE) and Iot is a received power spectral density of a total noise and interference for a certain RE; (b) uplink signal Io range, where Io is a total received power density, including signal and interference, as measured at a UE antenna connector of the UE; (c) uplink signal transmission bandwidth; (d) uplink signal subcarrier spacing; (e) downlink signal subcarrier spacing; (f) whether Frequency Division Duplexing, FDD, or Time Domain Duplexing, TDD, is used; (g) whether the access node is operating in frequency range 1, FR1, or frequency range 2, FR2; (h) an operating band of the access node; (i) an operating band combination being used; (j) a configured maximum transmission power of the UE; (k) a configured maximum transmission power of the UE on a serving cell of the UE; or (l) any two or more of (a)-(k).

In one embodiment, a method performed by a UE comprises receiving a downlink signal from an access node and deriving timing-related information based on the downlink signal, in accordance with a downlink signal timing detection error requirement that is a function of: a subcarrier spacing used for the downlink signal such that the downlink signal timing detection error requirement is inversely related to the subcarrier spacing used for the downlink signal; or a total bandwidth occupied by the downlink signal such that the downlink signal timing detection error requirement is inversely related to the total bandwidth occupied by the downlink signal; or both the subcarrier spacing used for the downlink signal and the total bandwidth occupied by the downlink signal.

In one embodiment, the downlink signal is: CSI-RS, TRS, DMRS, SSB, PRS, or any combination thereof.

Corresponding embodiments of a UE are also disclosed. In one embodiment, a UE is adapted to receive a downlink signal from an access node and derive timing-related information based on the downlink signal, in accordance with a downlink signal timing detection error requirement that is a function of: a subcarrier spacing used for the downlink signal such that the downlink signal timing detection error requirement is inversely related to the subcarrier spacing used for the downlink signal; or a total bandwidth occupied by the downlink signal such that the downlink signal timing detection error requirement is inversely related to the total bandwidth occupied by the downlink signal; or both the subcarrier spacing used for the downlink signal and the total bandwidth occupied by the downlink signal.

In one embodiment, a UE comprises a radio interface, one or more processors, and memory comprising instructions executable by the one or more processors whereby the UE is operable to receive a downlink signal from an access node and derive timing-related information based on the downlink signal, in accordance with a downlink signal timing detection error requirement that is a function of: a subcarrier spacing used for the downlink signal such that the downlink signal timing detection error requirement is inversely related to the subcarrier spacing used for the downlink signal; or a total bandwidth occupied by the downlink signal such that the downlink signal timing detection error requirement is inversely related to the total bandwidth occupied by the downlink signal; or both the subcarrier spacing used for the downlink signal and the total bandwidth occupied by the downlink signal.

In another embodiment, a method performed by a UE comprises transmitting an uplink signal to an access node, in accordance with an uplink signal transmit timing error requirement that initial UE transmission error is ±T_{eTSN} where T_{eTSN} is a UE transmit timing error limit value that is a function of: a subcarrier spacing used for the uplink signal; or a total bandwidth occupied by the uplink signal; or both the subcarrier spacing used for the uplink signal and the total bandwidth occupied by the uplink signal.

In one embodiment, the uplink signal is: CSI-RS, PRS, DMRS, TRS, or any combination thereof.

Corresponding embodiments of a UE are also disclosed. In one embodiment, a UE is adapted to transmit an uplink signal to an access node, in accordance with an uplink signal transmit timing error requirement that initial UE transmission error is ±T_{eTSN} where T_{eTSN} is a UE transmit timing error limit value that is a function of: a subcarrier spacing used for the uplink signal; or a total bandwidth occupied by the uplink signal; or both the subcarrier spacing used for the uplink signal and the total bandwidth occupied by the uplink signal.

In another embodiment, a UE comprises a radio interface, one or more processors, and memory comprising instructions executable by the one or more processors whereby the UE is operable to transmit an uplink signal to an access node, in accordance with an uplink signal transmit timing error requirement that initial UE transmission error is ±T_{eTSN} where T_{eTSN} is a UE transmit timing error limit value that is a function of: a subcarrier spacing used for the uplink signal; or a total bandwidth occupied by the uplink signal; or both the subcarrier spacing used for the uplink signal and the total bandwidth occupied by the uplink signal.

In one embodiment, a method performed by a UE for a wireless network comprises measuring a receive timing of a downlink subframe containing a downlink signal received from an access node, measuring a transmit timing of an uplink subframe that is closest in time to the downlink subframe containing the downlink signal, and deriving Rx-Tx timing of the UE based on the measured receive timing and the measured transmit timing. The Rx-Tx timing is derived in accordance with a defined Rx-Tx timing accuracy requirement that is a function of: (a) downlink signal Signal to Interference Plus Noise, SINR, Ês/Iot, where Ês is Received energy per Resource Element (RE) and Iot is a received power spectral density of a total noise and interference for a certain RE; (b) downlink signal Io range, where Io is a total received power density, including signal and interference, as measured at a UE antenna connector of the UE; (c) downlink signal transmission bandwidth; (d) downlink signal subcarrier spacing; (e) uplink signal subcarrier spacing; (f) whether Frequency Division Duplexing, FDD, or Time Domain Duplexing, TDD, is used; (g) whether the access node is operating in frequency range 1, FR1, or frequency range 2, FR2; (h) an operating band of the UE; (i) an operating band combination being used; or (j) any two or more of (a)-(i).

Corresponding embodiments of a UE are also disclosed. In one embodiment, a UE for a wireless network is adapted to measure a receive timing of a downlink subframe containing a downlink signal received from an access node, measure a transmit timing of an uplink subframe that is closest in time to the downlink subframe containing the downlink signal, and derive Rx-Tx timing of the UE based on the measured receive timing and the measured transmit timing. The Rx-Tx timing is derived in accordance with a defined Rx-Tx timing accuracy requirement that is a function of: (a) downlink signal Signal to Interference Plus Noise, SINR, Ês/Iot, where Ês is Received energy per Resource Element (RE) and Iot is a received power spectral density of a total noise and interference for a certain RE; (b) downlink signal Io range, where Io is a total received power density, including signal and interference, as measured at a UE antenna connector of the UE; (c) downlink signal transmission bandwidth; (d) downlink signal subcarrier spacing; (e) uplink signal subcarrier spacing; (f) whether Frequency Division Duplexing, FDD, or Time Domain Duplexing, TDD, is used; (g) whether the access node is operating in frequency range 1, FR1, or frequency range 2, FR2; (h) an operating band of the UE; (i) an operating band combination being used; or (j) any two or more of (a)-(i).

In another embodiment, a UE for a wireless network comprises a radio interface, one or more processors, and memory comprising instructions executable by the one or more processors whereby the UE is operable to measure a receive timing of a downlink subframe containing a downlink signal received from an access node, measure a transmit timing of an uplink subframe that is closest in time to the downlink subframe containing the downlink signal, and derive Rx-Tx timing of the UE based on the measured receive timing and the measured transmit timing. The Rx-Tx timing is derived in accordance with a defined Rx-Tx timing accuracy requirement that is a function of: (a) downlink signal Signal to Interference Plus Noise, SINR, Ês/Iot, where Ês is Received energy per Resource Element (RE) and Iot is a received power spectral density of a total noise and interference for a certain RE; (b) downlink signal Io range, where Io is a total received power density, including signal and interference, as measured at a UE antenna connector of the UE; (c) downlink signal transmission bandwidth; (d) downlink signal subcarrier spacing; (e) uplink signal subcarrier spacing; (f) whether Frequency Division Duplexing, FDD, or Time Domain Duplexing, TDD, is used; (g) whether the access node is operating in frequency range 1, FR1, or frequency range 2, FR2; (h) an operating band of the UE; (i) an operating band combination being used; or (j) any two or more of (a)-(i).

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 is a diagram illustrating TSN end-to-end timing delivery;

FIG. 2 is a flow chart illustrating a method implemented on an access node according to some embodiments of the present disclosure;

FIG. 3 is a flow chart illustrating a method implemented on a network node according to some embodiments of the present disclosure;

FIG. 4 is a flow chart illustrating a method implemented on a network node according to some embodiments of the present disclosure;

FIG. 5 is a flow chart illustrating a method implemented on a wireless communication device according to some embodiments of the present disclosure;

FIG. 6 is a flow chart illustrating a method implemented on a wireless communication device according to some embodiments of the present disclosure;

FIG. 7 is a flow chart illustrating a method implemented on a wireless communication device according to some embodiments of the present disclosure;

FIG. 8 illustrates a processor-based implementation of a network node which may be used for implementing the above-described embodiments; and

FIG. 9 illustrates a processor-based implementation of a wireless communication device which may be used for implementing the above-described embodiments.

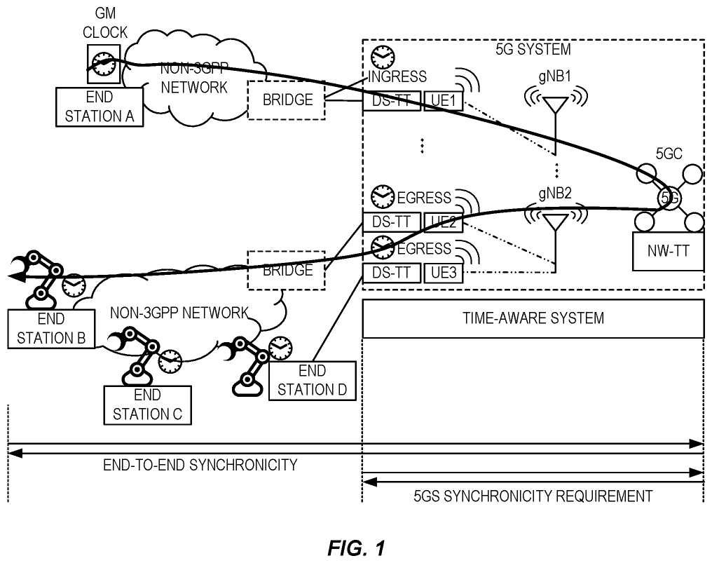

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

References in the specification to “one embodiment”, “an embodiment”, “an example embodiment” etc. indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the present disclosure. However, such notation should not be taken to mean that these are the only options or optional operations, and/or that blocks with solid borders are not optional in certain embodiments of the present disclosure.

In the following detailed description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, cooperate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other forms of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on, that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set of one or more physical network interfaces to establish network connections (to transmit and/or receive code and/or data using propagating signals) with other electronic devices. One or more parts of an embodiment of the present disclosure may be implemented using different combinations of software, firmware, and/or hardware.

Problems exist for the current solutions for Timing Sensitive Network (TSN) and Fifth Generation System (5GS) interworking. More specifically, in New Radio (NR) up to NR Release 16, the Timing Advance (TA) estimated based on the Physical Random Access Channel (PRACH) may have a detection time error larger than the requirement of maximum time error for a Time Sensitive Network (TSN), which makes the uplink timing at the next generation Node B (gNB) side not as synchronized as required by the TSN. This issue mainly happens in low band when a small Subcarrier Spacing (SCS) is applied as the number of Physical Resource Blocks (PRBs) used by one PRACH preamble transmission is fixed to be 12 PRBs. Thus, the PRACH bandwidth is smaller when a smaller SCS is used. This leads to larger detection error since the detection error is approximately the inverse of the uplink signal bandwidth.

When an enhanced PRACH design is introduced for clock synchronization in TSN, a different TA estimation accuracy requirement needs to be specified compared to the TA accuracy from normal PRACH detection. Furthermore, channels other than PRACH may also need to be enhanced when a clock synchronization is needed in case the User Equipment (UE) is in Radio Resource Control (RRC) connected state, e.g. an enhanced Sounding Reference Signal (SRS) channel can be introduced to estimate more accurate timing offset. In this case, a time synchronization accuracy requirement is also needed.

In addition to uplink signal (e.g., PRACH, Sounding Reference Signal (SRS)) related timing detection accuracy requirements, downlink signal (e.g., Channel State Information Reference Signal (CSI-RS), Positioning Reference Signal (PRS)) related timing detection accuracy requirements and UE transmit time accuracy requirements also have a need for enhanced timing synchronization between two nodes connected by the wireless link.

Systems and methods are disclosed herein that provide a solution(s) to the aforementioned and/or other challenges. The present disclosure provides methods for improving the time estimation accuracy to ensure the uplink synchronization in a TSN, including
Requirements of gNB uplink timing detection accuracy;
Requirements of UE downlink timing detection accuracy;
Requirements of UE transmit timing accuracy.

According to a first aspect of the present disclosure, a method for enhanced time synchronization between an access node and a wireless communication device (e.g., a UE) in a wireless communication network comprises the following steps carried out at the access node: (a) receiving a uplink channel transmission preamble for enhancing timing detection from the wireless communication device; (b) deriving timing-related information for respective SCS based on the preamble for enhancing timing detection; and (c) sending the timing-related information to the wireless communication device.

According to a second aspect of the present disclosure, a method for enhanced time synchronization between an access node and a wireless communication device in a wireless communication network comprises the following steps carried out at the access node: (a) receiving a uplink reference signal from the wireless communication device; (b) deriving timing-related information based on the uplink reference signal; and (c) sending the timing-related information to the wireless communication device.

According to a third aspect of the present disclosure, a method for enhanced time synchronization between an access node and a wireless communication device in a wireless communication network, comprising the following steps carried out at the access node: measuring the Transmission and Reception Point (TRP) received timing of uplink subframe #i containing SRS associated with wireless communication device and the TRP transmit timing of downlink subframe #j that is closest in time to the subframe #i received from the wireless communication device; deriving the receive-transmit time difference based on the TRP receiving timing of uplink subframe #i and the TRP transmit timing of downlink subframe #j.

In some embodiments, an error of the receive-transmit time difference is smaller than a predefined receive-transmit Time difference measurement accuracy.

According to a fourth aspect of the present disclosure, an access node, comprising: at least one processor; and a memory containing program code executable by the at least one processor, whereby execution of the program code by the at least one processor causes the access node to perform a method according to the above aspects.

According to a fifth aspect of the present disclosure, a computer program product being embodied in a computer readable storage medium and comprising program code to be executed by at least one processor of an access node, whereby execution of the program code causes the access node to perform a method according to the above aspects.

According to a sixth aspect of the present disclosure, a method for enhanced time synchronization between an access node and a wireless communication device in a wireless communication network, comprising the following steps carried out at the wireless communication device: (a) receiving from the access node a downlink signal; (b) deriving timing-related information based on the downlink signal.

According to a seventh aspect of the present disclosure, a method for enhanced time synchronization between an access node and a wireless communication device in a wireless communication network, comprising the following steps carried out at the wireless communication device: (a) sending to the access node an uplink signal; (b) receiving from the access node a timing-related information based on the uplink signal.

According to an eighth aspect of the present disclosure, a method for enhanced time synchronization between an access node and a wireless communication device in a wireless communication network, comprising the following steps carried out at the wireless communication device: measuring the wireless communication device received timing of downlink subframe #i from a Transmission Point (TP) and the wireless communication device transmit timing of uplink subframe #j that is closest in time to the subframe #i received from the TP; deriving the receive-transmit time difference based on the wireless communication device received timing of downlink subframe #i and the wireless communication device transmit timing of uplink subframe #j.

According to a ninth aspect of the present disclosure, an access node, comprising: at least one processor; and a memory containing program code executable by the at least one processor, whereby execution of the program code by the at least one processor causes the access node to perform a method according to the above aspects.

According to a tenth aspect of the present disclosure, a computer program product being embodied in a computer readable storage medium and comprising program code to be executed by at least one processor of an access node, whereby execution of the program code causes the access node to perform a method according to the above aspects.

In this way, the present disclosure provides methods on how to make the requirement of timing detection accuracy of different reference signals to ensure accurate clock synchronization in a 5G system. This is necessary to satisfy the stringent synchronization requirements between nodes in the 5G system for applications like the time sensitive network.

The present disclosure provides methods for defining the transmit and receive timing related requirements for gNB and/or UE operations, so as to ensure accurate clock synchronization in a 5G system. The same methods can be applied to satisfy the stringent synchronization requirements between any two nodes in the 5G system for applications like the time sensitive network, where the two nodes are connected via a wireless link.

In the discussion below, methods are described on timing requirements for gNB operation, as well as timing requirements for UE operation. In general, the timing requirements can be used for any scenarios and applications that require timing synchronization (also known as clock synchronization). A TSN is one typical use case, and a TSN is used for the discussion below. It is understood that the same methods and procedures can be applied to any other scenarios that need timing synchronization between two nodes that are connected via a wireless link. The wireless link between two nodes includes, but is not limited to, the following examples: (a) UE to UE link, also known as sidelink; (b) the link between the serving gNB and an Integrated Access and Backhaul (IAB) node; (c) the link between an IAB node and a UE connected to the IAB node. The wireless link may use shared spectrum channel access (aka, unlicensed spectrum, NR-U) or not using shared spectrum channel access (i.e., licensed spectrum).

It is noted that different applications, or different UE implementations, may use different requirements. For example, control-to-control use case may be applied with tighter requirements, while power grid use case may be applied with more relaxed requirements.

### Uplink Signal Timing Detection Error Requirement: PRACH

In order to support timing advance signaling with finer granularity, more accurate uplink signal timing detection is needed. This is a gNB performance requirement.

In one embodiment, stricter values compared to NR Release 15/16 for FR1 and/or FR2 can be defined for clock synchronization in the Third Generation Partnership Project (3GPP) standard.

As an example, for accurate clock synchronization purpose, for Additive White Gaussian Noise (AWGN) and Tapped Delay-Line (TDL) delay profile TDLC300-100, a timing estimation error occurs if the estimation error of the timing of the strongest path is larger than the time error tolerance given in Table 2 below for SCS with 15 kHz and 30 KHz.

TABLE 2
Time error tolerance for AWGN and
TDLC300-100 for clock synchronization

| PRACH | PRACH SCS | Time error tolerance | |
|---|---|---|---|
| Preamble | (kHz) | AWGN | TDLC300-100 |
| A1, A2, A3, B4, | 15 | 0.10 μs | 0.15 μs |
| C0, C2 | 30 | 0.05 μs | 0.10 μs |

In another example, for accurate clock synchronization purpose, for AWGN and TDLA30-300, a timing estimation error occurs if the estimation error of the timing of the strongest path is larger than the time error tolerance given in Table 3 below for SCS with 60 KHz and 120 kHz.

TABLE 3
Time error tolerance for AWGN and
TDLA30-300 for clock synchronization

| PRACH | PRACH SCS | Time error tolerance | |
|---|---|---|---|
| preamble | (kHz) | AWGN | TDLA30-300 |
| A1, A2, A3, B4, | 60 | 0.06 μs | 0.14 μs |
| C0, C2 | 120 | 0.03 μs | 0.11 μs |

In another embodiment, more than one time error tolerance requirements can be defined for different levels of UE and/or network capabilities. As an example, for SCS with 15 kHz and 30 kHz, two tables can be defined for time error tolerance for two different UE capability levels (see Tables 4 and 5 below).

TABLE 4
Time error tolerance for AWGN and TDLC300-100
for clock synchronization for UE capability 1

| PRACH | PRACH SCS | Time error tolerance | |
|---|---|---|---|
| preamble | (kHz) | AWGN | TDLC300-100 |
| A1, A2, A3, B4, | 15 | 0.10 μs | 0.15 μs |
| C0, C2 | 30 | 0.05 μs | 0.10 μs |

TABLE 5
Time error tolerance for AWGN and TDLC300-100
for clock synchronization for UE capability 2

| PRACH | PRACH SCS | Time error tolerance | |
|---|---|---|---|
| preamble | (kHz) | AWGN | TDLC300-100 |
| A1, A2, A3, B4, | 15 | 0.05 μs | 0.10 μs |
| C0, C2 | 30 | 0.03 μs | 0.05 s |

### Uplink Signal Timing Detection Error Requirement: SRS

Similar to PRACH, if SRS is the uplink signal used to provide higher accuracy uplink timing, then tighter requirement on timing detection error is needed for the network node. Typically, the network node is a gNB, or base station. Thus, this is a gNB (or base station) performance requirement.

In one embodiment, the SRS timing detection error is a function of the subcarrier spacing of SRS, with smaller timing error tolerance for larger SCS of SRS.

In another embodiment, the SRS timing detection error is a function of the total bandwidth occupied by the SRS. Typically, a smaller timing error tolerance is defined for a larger bandwidth of SRS.

In one embodiment, a set of time error tolerance values from SRS detection can be defined for clock synchronization in TSN in the 3GPP standard.

As an example, for TSN, for AWGN and TDLC300-100, a timing estimation error occurs if the estimation error of the timing of the strongest path is larger than the time error tolerance given in Table 6 below for SCS with 15 kHz, 30 KHz and 60 KHz.

TABLE 6
Time error tolerance for AWGN and TDLC300-100
for clock synchronization for FR1

| SRS | SRS | | Time error tolerance | |
|---|---|---|---|---|
| bandwidth | bandwidth | SRS SCS | | TDLC300- |
| (MHZ) | PRBs) | (kHz) | AWGN | 100 |
| ≥10 | ≥52 | 15 | 0.20 μs | 0.30 μs |
| ≥10 | ≥24 | 30 | 0.20 μs | 0.30 μs |
| ≥10 | ≥11 | 60 | 0.20 μs | 0.30 μs |
| ≥20 | ≥106 | 15 | 0.10 μs | 0.15 μs |
| ≥20 | ≥51 | 30 | 0.10 μs | 0.15 μs |
| ≥20 | ≥24 | 60 | 0.10 μs | 0.15 μs |
| ≥40 | ≥216 | 15 | 0.05 μs | 0.10 μs |
| ≥40 | ≥106 | 30 | 0.05 μs | 0.10 μs |
| ≥40 | ≥51 | 60 | 0.05 μs | 0.10 μs |

While Table 6 used SRS bandwidth of ≥10 MHZ, ≥20 MHZ, and ≥40 MHZ as illustration, it is noted that other bandwidths can be used, with corresponding SRS bandwidth in PRB, SRS SCS, and time error tolerance. In principle, for a given SRS bandwidth (MHZ), the same time error tolerance can be achieved regardless of SRS SCS.

In another example, for TSN, for AWGN and TDLA30-300, a timing estimation error occurs if the estimation error of the timing of the strongest path is larger than the time error tolerance given in Table 7 below for SCS with 60 KHz and 120 kHz. This corresponds to SRS bandwidth of 50 MHz for both SCS of 60 kHz and 120 KHz.

TABLE 7
Time error tolerance for AWGN and TDLA30-300
for clock synchronization for FR2

| SRS | SRS | | | |
|---|---|---|---|---|
| bandwidth | bandwidth | SRS SCS | Time error tolerance | |
| (MHz) | (PRBs) | (kHz) | AWGN | TDLA30-300 |
| ≥50 | ≥66 | 60 | 0.04 μs | 0.10 μs |
| ≥50 | ≥32 | 120 | 0.04 μs | 0.10 μs |
| ≥100 | ≥132 | 60 | 0.02 μs | 0.05 μs |
| ≥100 | ≥66 | 120 | 0.02 μs | 0.05 μs |

In another embodiment, more than one time error tolerance requirements can be defined for different levels of UE and/or network capabilities. As an example, for SCS with 15 kHz, 30 kHz and 60 kHz, two tables (Tables 8 and 9) as illustrated below can be defined for time error tolerance for two different UE capability levels. As illustrated, UE capability 1 corresponds to a lower UE capability (i.e., more relaxed UE implementation), where the UE transmits SRS of lower bandwidth, leading to larger timing error. UE capability 2 corresponds to a higher UE capability (i.e., more demanding UE implementation), where the UE transmits SRS of larger bandwidth, leading to reduced timing error.

TABLE 8
Time error tolerance for AWGN and TDLC300-100
for clock synchronization for UE capability 1

| SRS | SRS | | Time error tolerance | |
|---|---|---|---|---|
| bandwidth | bandwidth | SRS SCS | | TDLC300- |
| (MHz) | (PRBs) | (kHz) | AWGN | 100 |
| ≥10 | ≥52 | 15 | 0.20 us | 0.30 us |
| ≥10 | ≥24 | 30 | 0.20 us | 0.30 us |
| ≥10 | ≥11 | 60 | 0.20 us | 0.30 us |

TABLE 9
Time error tolerance for AWGN and TDLC300-100
for clock synchronization for UE capability 2

| SRS | SRS | | Time error tolerance | |
|---|---|---|---|---|
| bandwidth | bandwidth | SRS SCS | | TDLC300- |
| (MHz) | (PRBs) | (kHz) | AWGN | 100 |
| ≥20 | ≥106 | 15 | 0.10 us | 0.15 us |
| ≥20 | ≥51 | 30 | 0.10 us | 0.15 us |
| ≥20 | ≥24 | 60 | 0.10 us | 0.15 us |

While the timing detection error requirements are described as time error tolerance, it may be alternatively described as timing measurement accuracy, where the accuracy is describes as ±t_{Δ}. That is, the timing detection error is required to be within the range of (−t_{Δ}, +t_{Δ}).

While the timing detection error is described in units of seconds (or us (microseconds), or ns (nanoseconds), etc.), it is equally valid to describe in units of Tc, where Tc is the basic timing units in NR, T_{c}=1/(Δfₘₐₓ·N_{f}), where Δfₘₐₓ=480·10³ Hz and N_{f}=4096. Thus T_{c}=0.5086 ns.

It is also noted that while TDLC300-100 and TDLA30-300 channel models are used in defining the time error tolerance requirement, various other fading channel models and other channel parameters can be used instead, without deviating from the principles of the disclosed method.

### gNB Rx-Tx Time Difference Measurement Accuracy

In a Round-Trip Time (RTT) based propagation delay compensation method, the gNB Receive to Transmit (Rx-Tx) time difference is used in Type 1 and Type 2 Timing Advance (TADV) calculation. To ensure accurate clock synchronization, the gNB Rx-Tx time difference measurement accuracy needs to be specified.

In one embodiment, the gNB Rx-Tx time difference measurement accuracy is specified as a function of one or more of the parameters below:
Uplink signal Signal to Interference plus Noise Ratio (SINR) Ês/Iot (dB), where Ês is Received energy per Resource Element (RE), and Iot is the received power spectral density of the total noise and interference for a certain RE;
Uplink signal Io range, where Io is the total received power density, including signal and interference, as measured at the UE antenna connector.
Uplink signal transmission bandwidth (in MHZ);
Uplink signal SCS, for example, SCS of 15 kHz, or 30 kHz, or 60 KHz for FR1, and SCS of 60 kHz or 120 kHz for FR2;
Downlink signal SCS;
Frequency Division Duplexing (FDD) vs Time Domain Duplexing (TDD);
FR1 vs FR2;
Operating band;
Operating band combination;
P_{CMAX}, where P_{CMAX} is the configured UE maximum transmission power;
P_{CMAX}_{_{,c}}, where P_{CMAX}_{_{,c}} is the configured UE maximum transmission power on a serving cell c.

In general, the gNB can obtain uplink timing information based on any uplink signal/channel transmission, including PRACH, Physical Uplink Control Channel (PUCCH), Physical Uplink Shared Channel (PUSCH), SRS. Preferably, for more accurate measurement accuracy, the uplink signal is a type of uplink reference signal, such as SRS, Demodulation Reference Signal (DMRS), or Phase-Tracking Reference Signal (PTRS).

### Downlink Signal Timing Detection Error Requirement

When UE is the receiver of downlink signal timing, detection time error tolerance needs to be introduced as well. The downlink signal timing detection error requirement is a UE performance requirement.

The downlink signal can be one or more of: CSI-RS, TRS, DMRS, Synchronization Signal Block (SSB), or PRS.

In one embodiment, the downlink signal timing detection error is a function of the subcarrier spacing of the downlink signal used in the measurement. Typically, a smaller timing error tolerance is defined for a larger SCS of downlink signal.

In another embodiment, the downlink signal timing detection error is a function of the total bandwidth occupied by the downlink signal. Typically, a smaller timing error tolerance is defined for a larger bandwidth of the downlink signal used in the measurement.

In one embodiment, a set of required values are defined Timing Detection Error Limit based on downlink reference signals for clock synchronization.

As an example, a time detection error table can be defined for CSI-RS for clock synchronization. For instance, a table like Table 10 can be used, where TD_{eTSN} represents the downlink signal timing detection error limit (i.e., timing accuracy requirement). While a value tΔ (e.g., 64*Tc) is given in Table 10, it is understood that the timing detection error is required to be within (−tΔ, +tΔ), for instance, (−64*Tc, +64*Tc).

TABLE 10
TD_{eTSN} Timing Detection Error Limit based on
CSI-RS for clock synchronization

| | SCS of | Bandwidth | |
|---|---|---|---|
| Frequency | CSI-RS | of CSI-RS | |
| Range | (KHz) | (MHz) | TD_{eTSN} |
| 1 | 15 | ≥10 | 4*64*T_{c} |
| | | ≥20 | 2*64*T_{c} |
| | | ≥40 | 64*T_{c} |
| | 30 | ≥10 | 4*64*T_{c} |
| | | ≥20 | 2*64*T_{c} |
| | | ≥40 | 64*T_{c} |
| | 60 | ≥20 | 2*64*T_{c} |
| | | ≥40 | 64*T_{c} |
| | | ≥80 | 32*T_{c} |
| 2 | 60 | ≥40 | 64*T_{c} |
| | | ≥80 | 32*T_{c} |
| | | ≥160 | 16*T_{c} |
| | 120 | ≥40 | 64*T_{c} |
| | | ≥80 | 32*T_{c} |
| | | ≥160 | 16*T_{c} |

Note 1:
T_{c} is the basic timing unit defined in TS 38.211

### Uplink Signal Transmit Time Error Requirement

In one embodiment, a more stringent requirement can be defined for UL signal transmit error requirement for clock synchronization. This is a UE performance requirement.

As an example, in Table 11, for more accurate timing synchronization, the

UE initial transmission timing error shall be less than or equal to +T_{eTSN} where the UE transmit timing error limit value T_{eTSN} is specified in Table 11. This requirement applies when it is the first transmission in a Discontinuous Reception (DRX) cycle for PUCCH, PUSCH, and SRS or it is the PRACH transmission.

The UE shall meet the T_{eTSN} requirement for an initial transmission provided that at least one SSB is available at the UE during the last 160 ms. The reference point for the UE initial transmit timing control requirement shall be the downlink timing of the reference cell minus (N_{TA}+N_{TAoffset})×T_{c}. The downlink timing is defined as the time when the first detected path (in time) of the corresponding downlink frame is received from the reference cell. N_{TA} for PRACH is defined as 0.

It is noted that while SSB is used in discussion above, other types of downlink reference signal can be used in defining the U16E transmit timing error, including CSI-RS, PRS, DMRS, TRS.

TABLE 11
T_{eTSN} (UE Transmit Training Error) Limit for clock synchronization

| | SCS of | | |
|---|---|---|---|
| | downlink | SCS of | |
| | reference | uplink | |
| Frequency | signals | signals | |
| Range | (KHz) | (KHz) | T_{eTSN} |
| 1 | 15 | 15 | 3*64*T_{c} |
| | | 30 | 2.5*64*T_{c} |
| | | 60 | 2.5*64*T_{c} |
| | 30 | 15 | 2*64*T_{c} |
| | | 30 | 2*64*T_{c} |
| | | 60 | 1.5*64*T_{c} |
| 2 | 120 | 60 | 64*T_{c} |
| | | 120 | 64*T_{c} |
| | 240 | 60 | 64*T_{c} |
| | | 120 | 64*T_{c} |

Note 1:
T_{c} is the basic timing unit defined in TS 38.211

While a value t_{Δ} (e.g., 64*T_{c}) is given in Table 11 for UE transmit timing accuracy requirement, it is understood that the UE transmit timing accuracy is required to be within (−t_{Δ}, +t_{Δ}), for instance, (−64*T_{c}, +64*T_{c}).

### UE Rx-Tx Time Difference Measurement Accuracy

In RTT based propagation delay compensation method, UE Rx-Tx time difference is used in Type 1 Timing Advance (T_{ADV}) calculation. To ensure accurate clock synchronization, the UE Rx-Tx time difference measurement accuracy needs to be specified. The UE RxTx time difference measurement accuracy is a UE performance requirement.

In one embodiment, UE Rx-Tx time difference measurement accuracy is specified as a function of one or more parameters below:
Downlink signal SINR Ês/Iot (dB), where Ês is Received energy per RE, and Iot is the received power spectral density of the total noise and interference for a certain RE;
Downlink signal Io range, where Io is the total received power density, including signal and interference, as measured at the UE antenna connector.
Downlink signal transmission bandwidth (in MHZ);
Downlink signal SCS, for example, SCS of 15 kHz, or 30 kHz, or 60 KHz for FR1, and SCS of 60 KHz, or 120 kHz for FR2;
Uplink signal SCS;
FDD vs TDD;
FR1 vs FR2;
Operating band;
Operating band combination.

### Other Considerations

In general, the gNB can obtain uplink timing information based on any uplink signal/channel transmission, including PRACH, PUCCH, PUSCH, SRS. Preferably, for more accurate measurement accuracy, the uplink signal is a type of uplink reference signal, such as SRS, DMRS, PTRS.

In one embodiment, the above enhanced performance requirement applies only for the DL dedicated Radio Resource Control (RRC) message or the System Information Block (SIB) 9 (SIB9) that contains the reference timing. In other words, if the UE has indicated that it supports reference time delivery and the UE is aware that the network has configured the accurate reference time delivery to the UE, the UE starts to use the enhanced performance requirement table(s).

In one follow-up embodiment, a time period in which the accurate reference time may be delivered is configured to the UE, and the UE only uses the enhanced performance requirement table during this period. The reason is that the UE is not aware in advance which user plane message may contain the dedicated reference time delivery, and this approach can save UE implementation cost in using the more stringent requirement all the time, e.g., to save UE power consumption.

In one embodiment, the above enhanced performance requirement applies only for the Primary Cell (PCell) of the Master Cell Group (MCG). For other cells, such as the Secondary Cells (SCells) in both the MCG and the Secondary Cell Group (SCG) or the Primary SCell (PSCell) in the SCG. The reason is that it has been agreed in Release 16 that the reference time is referred to the System Frame Number (SFN) of the PCell and there is no need to have a stringent performance requirement on the cells for which there is no reference time delivery.

In another embodiment, the above enhanced performance requirement on the UL applies only for the PCell while the above enhanced performance requirement on the DL applies for all cells in the MCG. The reason is that for the dedicated RRC signaling that contains the reference timing, the RRC message might be transmitted in any of the cells in the MCG. In a follow-up embodiment, the above enhancement performance requirement on the DL can also apply only for the PCell given the condition that the RRC dedicated signaling that contains the reference timing is restricted to be transmitted on the PCell.

In another embodiment, the above enhancement performance requirement applies only when Carrier Aggregation (CA) is not configured or when only a limited number of carriers (smaller than the maximum number of carriers that can be supported otherwise) are supported or when Dual Connectivity (DC) is not supported.

In another embodiment, the enhanced performance requirement applies only for a certain carrier frequency range. For example, the enhanced performance requirement is defined only for FR1 for the power grid use case. Alternatively, the enhanced performance requirement is defined only for FR2 for the factory automation use case.

### Further Description

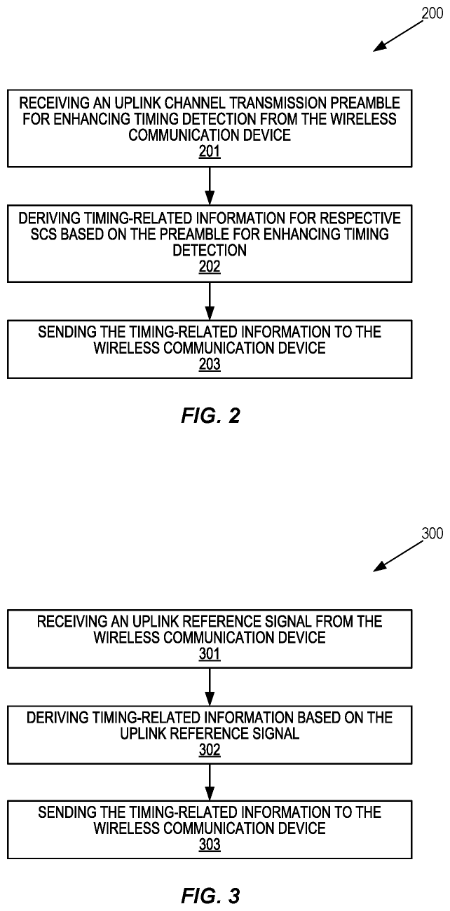

FIG. 2 is a flow chart illustrating a method 200 implemented on an access node according to some embodiments of the present disclosure. As an example, operations of this flow chart may be performed by an access node, but they are not limited thereto. The operations in this and other flow charts will be described with reference to the exemplary embodiments of the other figures. However, it should be appreciated that the operations of the flow charts may be performed by embodiments of the present disclosure other than those discussed with reference to the other figures, and the embodiments of the present disclosure discussed with reference to these other figures may perform operations different than those discussed with reference to the flow charts.

In one embodiment, the access node may receive an uplink channel transmission preamble for enhancing timing detection from the wireless communication device (block 201) deriving timing-related information for respective subcarrier spacing (SCS) based on the preamble for enhancing timing detection (block 202) and sending the timing-related information to the wireless communication device (block 203).

As an example, the access node is eNB or gNB, and the wireless communication device is selected from a group consisting of User Equipment (UE),

Tablet, mobile terminals, smart phone, laptop embedded equipped, laptop mounted equipment, and Internet of Things (IoT) device.

As an example, the timing-related information is an Uplink signal timing detection error requirement for respective SCS.

As a further example, one or more Uplink signal timing detection error requirements are defined for wireless communication devices of different levels of UE and/or network capabilities.

As a further example, the uplink channel transmission comprising Physical Random Access Channel (PRACH), Physical Uplink Control Channel (PUCCH) and Physical Uplink Shared Channel (PUSCH).

As a further example, the timing-related information applies only for Downlink delicate RRC message or the SIB9 that contains the reference timing.

As a further example, the timing-related information applies only during the period in which the accurate reference time may be delivered is configured to the UE.

As a further example, the timing-related information applies only for the Primary Cell (PCell) of the master cell group (MCG).

As an example, the timing-related information applies only when the Carrier Aggregation (CA) is not configured or when only a limited number of carriers are supported or when a dual connectivity (DC) is not supported.

As a further example, the timing-related information applies only for a certain carrier frequency range.

FIG. 3 is a flow chart illustrating a method 300 implemented on an access node according to some embodiments of the present disclosure.

In one embodiment, the access node may receive an uplink reference signal from the wireless communication device (block 301). The network node may derive timing-related information based on the uplink reference signal (block 302). The network node may send the timing-related information to the wireless communication device (block 303).

As an example, the access node is eNB or gNB, and the wireless communication device is selected from a group consisting of User Equipment (UE), Tablet, mobile terminals, smart phone, laptop embedded equipped, laptop mounted equipment, and Internet of Things (IoT) device.

As a further example, the timing-related information is an Uplink signal timing detection error requirement for respective subcarrier spacing (SCS) of SRS.

As a further example, the Uplink signal timing detection error requirement is one or more of a function of a subcarrier spacing of the SRS, a function of the total bandwidth occupied by the SRS, and clock synchronization in TSN in a standard.

As a further example, one or more Uplink signal timing detection error requirements are defined for wireless communication devices of different levels of UE and/or network capabilities.

As a further example, the uplink reference signal comprises Sounding Reference Signal (SRS), Demodulation Reference Signal (DMRS) and Phase Tracking Reference Signal (PTRS).

As an example, the timing-related information applies only for Downlink delicate RRC message or the SIB9 that contains the reference timing.

As a further example, the timing-related information applies only during the period in which the accurate reference time may be delivered is configured to the UE.

As an example, the timing-related information applies only for the Primary Cell (PCell) of the master cell group (MCG).

As a further example, the timing-related information applies only when the Carrier Aggregation (CA) is not configured or when only a limited number of carriers are supported or when a dual connectivity (DC) is not supported.

As a further example, the timing-related information applies only for a certain carrier frequency range.

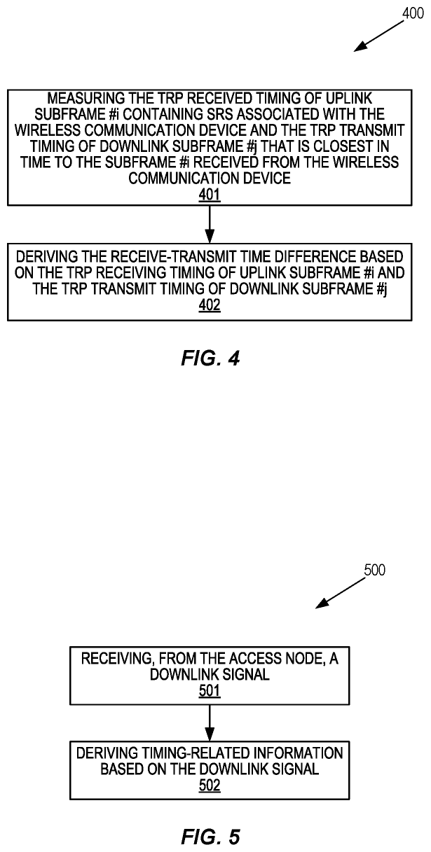

FIG. 4 is a flow chart illustrating a method 400 implemented on an access node according to some embodiments of the present disclosure.

In one embodiment, the access node may measure the Transmission and Reception Point (TRP) received timing of uplink subframe #i containing SRS associated with wireless communication device and the TRP transmit timing of downlink subframe #j that is closest in time to the subframe #i received from the wireless communication device (block 401). The network node may derive the receive-transmit time difference based on the TRP receiving timing of uplink subframe #i and the TRP transmit timing of downlink subframe #j (block 402).

As an example, an error of the receive-transmit time difference is smaller than a predefined receive-transmit Time difference measurement accuracy.

As a further example, the Receive-Transmit time difference measurement accuracy is a function of one or more of the following parameters:
Uplink signal SINR Ês/Iot (dB), where Ês is Received energy per RE, and
Iot is the received power spectral density of the total noise and interference for a certain RE;
Uplink signal Io range, where Io is the total received power density, including signal and interference, as measured at the UE antenna connector.
Uplink signal transmission bandwidth;
Uplink signal SCSs;
Downlink signal SCS;
Frequency-division duplexing vs Time-division duplexing;
Frequency Range 1 vs Frequency Range 2;
Operating band;
Operating band combination;
P_{CMAX}, where P_{CMAX} is the configured UE maximum transmission power; and
P_{CMAX}_{_{,c}}, where P_{CMAX}_{_{,c}} is the configured UE maximum transmission power on a serving cell c.

As a further example, the Receive-Transmit time difference measurement accuracy applies only for Downlink delicate RRC message or the SIB9 that contains the reference timing.

As a further example, the Receive-Transmit time difference measurement accuracy applies only during the period in which the accurate reference time may be delivered is configured to the UE.

FIG. 5 is a flow chart illustrating a method 500 implemented on a wireless communication device according to some embodiments of the present disclosure.

In one embodiment, the wireless communication device may receive from the access node a downlink signal (block 501). The wireless communication device may derive timing-related information based on the downlink signal (block 502).

As an example, the access node is eNB or gNB, and the wireless communication device is selected from a group consisting of User Equipment (UE), Tablet, mobile terminals, smart phone, laptop embedded equipped, laptop mounted equipment, and Internet of Things (IoT) device.

As a further example, the timing-related information is a Downlink signal timing detection error requirement.

As a further example, the downlink signal can be one or more of: CSI-RS, TRS, DMRS, SSB, and PRS.

As a further example, the Downlink signal timing detection error requirement is one or more of a function of the subcarrier spacing of the downlink signal, a function of the total bandwidth occupied by the downlink signal and a set of required values defined Timing Detection Error Limit based on downlink reference signals.

As a further example, the timing-related information applies only for Downlink delicate RRC message or the SIB9 that contains the reference timing. As an example, the timing-related information applies only during the period in which the accurate reference time may be delivered is configured to the UE.

As a further example, the timing-related information applies for all cells in the master cell group.

As an example, the timing-related information applies only when the Carrier Aggregation (CA) is not configured or when only a limited number of carriers are supported or when a dual connectivity (DC) is not supported.

As a further example, the timing-related information applies only for a certain carrier frequency range.

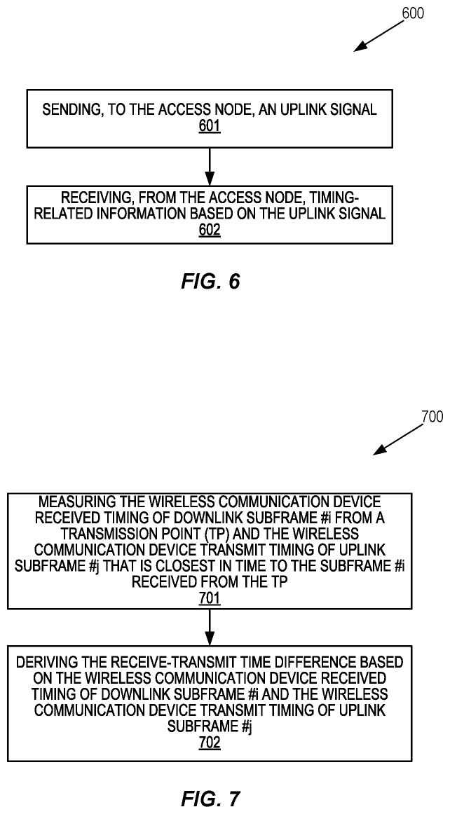

FIG. 6 is a flow chart illustrating a method 600 implemented on a wireless communication device according to some embodiments of the present disclosure.

In one embodiment, the wireless communication device may send to the access node an uplink signal (block 601). The wireless communication device may receive from the access node a timing-related information based on the uplink signal (block 602).

As an example, the access node is eNB or gNB, and the wireless communication device is selected from a group consisting of User Equipment (UE),

Tablet, mobile terminals, smart phone, laptop embedded equipped, laptop mounted equipment, and Internet of Things (IoT) device.

As a further example, the timing-related information is an Uplink signal transmit time error requirement.

As a further example, the downlink signal can be one or more of: CSI-RS, TRS, DMRS, SSB, and PRS.

As a further example, the timing-related information applies only for Downlink delicate RRC message or the SIB9 that contains the reference timing.

As a further example, the timing-related information applies only during the period in which the accurate reference time may be delivered is configured to the UE.

As an example, the timing-related information applies for all cells in the master cell group.

As a further example, the timing-related information applies only when the Carrier Aggregation (CA) is not configured or when only a limited number of carriers are supported or when a dual connectivity (DC) is not supported.

As an example, the timing-related information applies only for a certain carrier frequency range.

FIG. 7 is a flow chart illustrating a method 700 implemented on a wireless communication device according to some embodiments of the present disclosure.

In one embodiment, the wireless communication device may measure the wireless communication device received timing of downlink subframe #i from a Transmission Point (TP) and the wireless communication device transmit timing of uplink subframe #j that is closest in time to the subframe #i received from the TP (block 701). The wireless communication device may derive the receive-transmit time difference based on the wireless communication device received timing of downlink subframe #i and the wireless communication device transmit timing of uplink subframe #j (block 702).

As an example, an error of the receive-transmit time difference is smaller than a predefined receive-transmit Time difference measurement accuracy.

As a further example, the Receive-Transmit time difference measurement accuracy is a function of one or more of the following parameters:
Downlink signal SINR Ês/Iot (dB), where Ês is Received energy per RE, and Iot is the received power spectral density of the total noise and interference for a certain RE;
Downlink signal Io range, where Io is the total received power density, including signal and interference, as measured at the UE antenna connector.
Downlink signal transmission bandwidth;
Downlink signal SCS;
Uplink signal SCS;
Frequency-division duplexing vs Time-division duplexing;
Frequency Range 1 vs Frequency Range 2;
Operating band;
Operating band combination.

As a further example, the Receive-Transmit time difference measurement accuracy applies only for Downlink delicate RRC message or the SIB9 that contains the reference timing.

As a further example, the Receive-Transmit time difference measurement accuracy applies only during the period in which the accurate reference time may be delivered is configured to the UE.

FIG. 8 illustrates a processor-based implementation of a network node which may be used for implementing the above-described embodiments. For example, the structures as illustrated in FIG. 8 may be used for implementing the concepts in any of the above-mentioned access nodes.

As illustrated, the node 800 may include one or more radio interfaces 810. The radio interface(s) 810 may for example be based on the NR technology or the LTE technology. The radio interface(s) 810 may be used for controlling wireless communication devices, such as any of the above-mentioned UEs. In addition, the node 800 may include one or more network interfaces 820. The network interface(s) 820 may for example be used for communication with one or more other nodes of the wireless communication network.

Further, the node 800 may include one or more processors 830 coupled to the interfaces 810, 820 and a memory 840 coupled to the processor(s) 830. By way of example, the interfaces 810, 820, the processor(s) 830, and the memory 840 could be coupled by one or more internal bus systems of the node 800. The memory 840 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 840 may include software 850 and/or firmware 860. The memory 840 may include suitably configured program code to be executed by the processor(s) 830 so as to implement the above-described functionalities for time synchronization, such as explained in connection with FIGS. 2 to 7.

It is to be understood that the structure as illustrated in FIG. 8 is merely schematic and that the node 800 may actually include further components which, for the sake of clarity, have not been illustrated, e.g., further interfaces, such as a dedicated management interface, or further processors. Also, it is to be understood that the memory 840 may include further program code for implementing known functionalities of an eNB or gNB.

According to some embodiments, also a computer program may be provided for implementing functionalities of the node 800, e.g., in the form of a physical medium storing the program code and/or other data to be stored in the memory 840 or by making the program code available for download or by streaming.

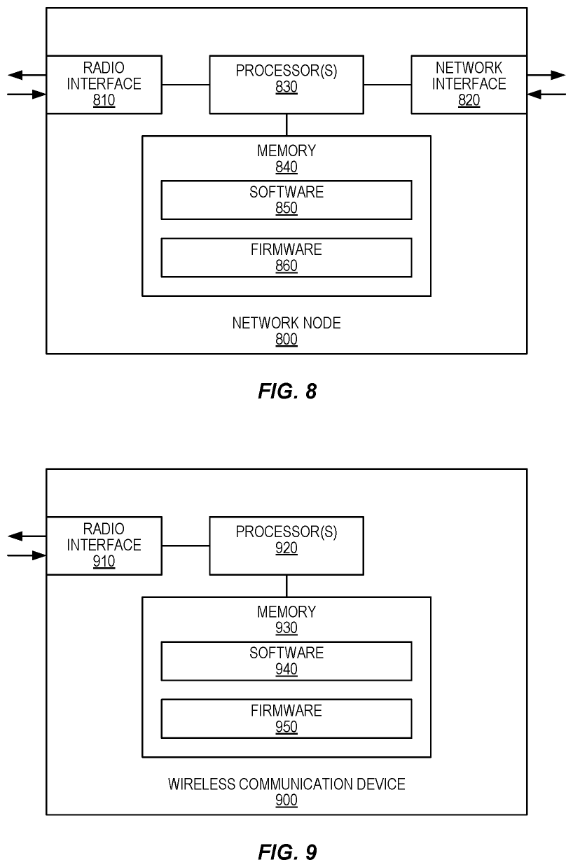

FIG. 9 illustrates a processor-based implementation of a wireless communication device which may be used for implementing the above-described embodiments.

As illustrated, the wireless communication device 900 includes one or more radio interfaces 910. The radio interface(s) 910 may for example be based on the NR technology or the LTE technology.

Further, the wireless communication device 900 may include one or more processors 920 coupled to the radio interface(s) 910 and a memory 930 coupled to the processor(s) 920.

By way of example, the radio interface(s) 910, the processor(s) 920, and the memory 930 could be coupled by one or more internal bus systems of the wireless communication device 900. The memory 930 may include a Read-Only-Memory (ROM), e.g., a flash ROM, a Random Access Memory (RAM), e.g., a Dynamic RAM (DRAM) or Static RAM (SRAM), a mass storage, e.g., a hard disk or solid state disk, or the like. As illustrated, the memory 930 may include software 940 and/or firmware 950. The memory 930 may include suitably configured program code to be executed by the processor(s) 920 so as to implement the above-described functionalities for time synchronization, such as explained in connection with FIGS. 2 to 7.

It is to be understood that the structure as illustrated in FIG. 9 is merely schematic and that the wireless communication device 900 may actually include further components which, for the sake of clarity, have not been illustrated, e.g., further interfaces, such as a dedicated management interface, or further processors. Also, it is to be understood that the memory 930 may include further program code for implementing known functionalities of a UE.

According to some embodiments, also a computer program may be provided for implementing functionalities of the wireless communication device 900, e.g., in the form of a physical medium storing the program code and/or other data to be stored in the memory 930 or by making the program code available for download or by streaming.

Some portions of the foregoing detailed description have been presented in terms of algorithms and symbolic representations of transactions on data bits within a computer memory. These algorithmic descriptions and representations are ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be appreciated, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to actions and processes of a computer system, or a similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present disclosure are not described with reference to any particular programming language. It should be appreciated that a variety of programming languages may be used to implement the teachings of embodiments of the present disclosure as described herein.

An embodiment of the present disclosure may be an article of manufacture in which a non-transitory machine-readable medium (such as microelectronic memory) has stored thereon instructions (e.g., computer code) which program one or more data processing components (generically referred to here as a “processor”) to perform the operations described above. In other embodiments, some of these operations might be performed by specific hardware components that contain hardwired logic (e.g., dedicated digital filter blocks and state machines). Those operations might alternatively be performed by any combination of programmed data processing components and fixed hardwired circuit components.

In the foregoing detailed description, embodiments of the present disclosure have been described with reference to specific exemplary embodiments thereof. It will be evident that various modifications may be made thereto without departing from the spirit and scope of the present disclosure as set forth in the following claims. The specification and drawings are, accordingly, to be regarded in an illustrative sense rather than a restrictive sense.

Throughout the description, some embodiments of the present disclosure have been presented through flow diagrams. It should be appreciated that the order of transactions and transactions described in these flow diagrams are only intended for illustrative purposes and not intended as a limitation of the present disclosure. One having ordinary skill in the art would recognize that variations can be made to the flow diagrams without departing from the spirit and scope of the present disclosure as set forth in the following claims.

Some example embodiments of the present disclosure are as follows:

Embodiment 1: A method for enhanced time synchronization between an access node and a wireless communication device in a wireless communication network, comprising the following steps carried out at the access node: (a) receiving a uplink channel transmission preamble for enhancing timing detection from the wireless communication device; (b) deriving timing-related information for respective subcarrier spacing (SCS) based on the preamble for enhancing timing detection; and (c) sending the timing-related information to the wireless communication device.

Embodiment 2: The method according to embodiment 1, wherein the access node is eNB or gNB, and the wireless communication device is selected from a group consisting of User Equipment (UE), Tablet, mobile terminals, smart phone, laptop embedded equipped, laptop mounted equipment, and Internet of Things (IoT) device.

Embodiment 3: The method according to embodiment 1 or 2, wherein the timing-related information is an Uplink signal timing detection error requirement for respective SCS.

Embodiment 4: The method according to any of embodiments 1-3, wherein one or more Uplink signal timing detection error requirements are defined for wireless communication devices of different levels of UE and/or network capabilities.

Embodiment 5: The method according to any of embodiments 1-4, wherein the uplink channel transmission comprising Physical Random Access Channel

(PRACH), Physical Uplink Control Channel (PUCCH) and Physical Uplink Shared Channel (PUSCH).

Embodiment 6: The method according to any of embodiments 1-5, wherein the timing-related information applies only for Downlink delicate RRC message or the SIB9 that contains the reference timing.

Embodiment 7: The method according to any of embodiments 1-6, wherein the timing-related information applies only during the period in which the accurate reference time may be delivered is configured to the UE.

Embodiment 8: The method according to any of embodiments 1-7, wherein the timing-related information applies only for the Primary Cell (PCell) of the master cell group (MCG).

Embodiment 9: The method according to any of embodiments 1-8, wherein the timing-related information applies only when the Carrier Aggregation (CA) is not configured or when only a limited number of carriers are supported or when a dual connectivity (DC) is not supported.

Embodiment 10: The method according to any of embodiments 1-9, wherein the timing-related information applies only for a certain carrier frequency range.

Embodiment 11: A method for enhanced time synchronization between an access node and a wireless communication device in a wireless communication network, comprising the following steps carried out at the access node: (a) receiving an uplink reference signal from the wireless communication device; (b) deriving timing-related information based on the uplink reference signal; and (c) sending the timing-related information to the wireless communication device.

Embodiment 12: The method according to embodiment 11, wherein the access node is eNB or gNB, and the wireless communication device is selected from a group consisting of User Equipment (UE), Tablet, mobile terminals, smart phone, laptop embedded equipped, laptop mounted equipment, and Internet of Things (IoT) device.

Embodiment 13: The method according to embodiment 11 or 12, wherein the timing-related information is an uplink signal timing detection error requirement for respective subcarrier spacing (SCS) of SRS.

Embodiment 14: The method according to any of embodiments 11-13, wherein the Uplink signal timing detection error requirement is one or more of a function of a subcarrier spacing of the SRS, a function of the total bandwidth occupied by the SRS, and clock synchronization in TSN in a standard.

Embodiment 15: The method according to any of embodiments 11-14, wherein one or more Uplink signal timing detection error requirements are defined for wireless communication devices of different levels of UE and/or network capabilities.

Embodiment 16: The method according to any of embodiments 11-15, wherein the uplink reference signal comprises Sounding Reference Signal (SRS), Demodulation Reference Signal (DMRS) and Phase Tracking Reference Signal (PTRS).

Embodiment 17: The method according to any of embodiments 11-16, wherein the timing-related information applies only for Downlink delicate RRC message or the SIB9 that contains the reference timing.

Embodiment 18: The method according to any of embodiments 11-17, wherein the timing-related information applies only during the period in which the accurate reference time may be delivered is configured to the UE.

Embodiment 19: The method according to any of embodiments 11-18, wherein the timing-related information applies only for the Primary Cell (PCell) of the master cell group (MCG).

Embodiment 20: The method according to any of embodiments 11-19, wherein the timing-related information applies only when the Carrier Aggregation (CA) is not configured or when only a limited number of carriers are supported or when a dual connectivity (DC) is not supported.

Embodiment 21: The method according to any of embodiments 11-20, wherein the timing-related information applies only for a certain carrier frequency range.

Embodiment 22: A method for enhanced time synchronization between an access node and a wireless communication device in a wireless communication network, comprising the following steps carried out at the access node: measuring the Transmission and Reception Point (TRP) received timing of uplink subframe #i containing SRS associated with wireless communication device and the TRP transmit timing of downlink subframe #j that is closest in time to the subframe #i received from the wireless communication device; and deriving the receive-transmit time difference based on the TRP receiving timing of uplink subframe #i and the TRP transmit timing of downlink subframe #j.

Embodiment 23: The method according to embodiment 22, wherein an error of the receive-transmit time difference is smaller than a predefined receive-transmit Time difference measurement accuracy.

Embodiment 24: The method according to embodiment 22 or 23, wherein the Receive-Transmit time difference measurement accuracy is a function of one or more of the following parameters:
Uplink signal SINR Ês/Iot (dB), where Ês is Received energy per RE, and Iot is the received power spectral density of the total noise and interference for a certain RE;
Uplink signal Io range, where Io is the total received power density, including signal and interference, as measured at the UE antenna connector.
Uplink signal transmission bandwidth;
Uplink signal SCSs;
Downlink signal SCS;
Frequency-division duplexing vs Time-division duplexing;
Frequency Range 1 vs Frequency Range 2;
Operating band;
Operating band combination;
P_{CMAX}, where P_{CMAX} is the configured UE maximum transmission power; and
P_{CMAX}_{_{,c}}, where P_{CMAX}_{_{,c}} is the configured UE maximum transmission power on a serving cell c.

Embodiment 25: The method according to any of embodiments 22-24, wherein the Receive-Transmit time difference measurement accuracy applies only for Downlink delicate RRC message or the SIB9 that contains the reference timing.

Embodiment 26: The method according to any of embodiments 22-25, wherein the Receive-Transmit time difference measurement accuracy applies only during the period in which the accurate reference time may be delivered is configured to the UE.

Embodiment 27: An access node, comprising: at least one processor; and a memory containing program code executable by the at least one processor, whereby execution of the program code by the at least one processor causes the access node to perform a method according to anyone of embodiments 1-26.

Embodiment 28: A computer program product being embodied in a computer readable storage medium and comprising program code to be executed by at least one processor of an access node, whereby execution of the program code causes the access node to perform a method according to any one of embodiments 1-26.

Embodiment 29: A method for enhanced time synchronization between an access node and a wireless communication device in a wireless communication network, comprising the following steps carried out at the wireless communication device: (a) receiving from the access node a downlink signal; (b) deriving timing-related information based on the downlink signal.

Embodiment 30: The method according to embodiment 29, wherein the access node is eNB or gNB, and the wireless communication device is selected from a group consisting of User Equipment (UE), Tablet, mobile terminals, smart phone, laptop embedded equipped, laptop mounted equipment, and Internet of Things (IoT) device.

Embodiment 31: The method according to embodiment 29 or 30, wherein the timing-related information is a Downlink signal timing detection error requirement.

Embodiment 32: The method according to any of embodiments 29-31, wherein the downlink signal can be one or more of: CSI-RS, TRS, DMRS, SSB, and PRS.

Embodiment 33: The method according to any of embodiments 29-32, wherein the Downlink signal timing detection error requirement is one or more of a function of the subcarrier spacing of the downlink signal, a function of the total bandwidth occupied by the downlink signal and a set of required values defined Timing Detection Error Limit based on downlink reference signals.

Embodiment 34: The method according to any of embodiments 29-33, wherein the timing-related information applies only for Downlink delicate RRC message or the SIB9 that contains the reference timing.

Embodiment 35: The method according to any of embodiments 29-34, wherein the timing-related information applies only during the period in which the accurate reference time may be delivered is configured to the UE.

Embodiment 36: The method according to any of embodiments 29-35, wherein the timing-related information applies for all cells in the master cell group.

Embodiment 37: The method according to any of embodiments 29-36, wherein the timing-related information applies only when the Carrier Aggregation (CA) is not configured or when only a limited number of carriers are supported or when a dual connectivity (DC) is not supported.

Embodiment 38: The method according to any of embodiments 29-37, wherein the timing-related information applies only for a certain carrier frequency range.

Embodiment 39: A method for enhanced time synchronization between an access node and a wireless communication device in a wireless communication network, comprising the following steps carried out at the wireless communication device: (a) sending to the access node an uplink signal; and (b) receiving from the access node a timing-related information based on the uplink signal.

Embodiment 40: The method according to embodiment 39, wherein the access node is eNB or gNB, and the wireless communication device is selected from a group consisting of User Equipment (UE), Tablet, mobile terminals, smart phone, laptop embedded equipped, laptop mounted equipment, and Internet of Things (IoT) device.

Embodiment 41: The method according to embodiment 39 or 40, wherein the timing-related information is an Uplink signal transmit time error requirement.

Embodiment 42: The method according to any of embodiments 39-41, wherein the downlink signal can be one or more of: CSI-RS, TRS, DMRS, SSB, and PRS.

Embodiment 43: The method according to any of embodiments 39-42, wherein the timing-related information applies only for Downlink delicate RRC message or the SIB9 that contains the reference timing.

Embodiment 44: The method according to any of embodiments 39-43, wherein the timing-related information applies only during the period in which the accurate reference time may be delivered is configured to the UE.

Embodiment 45: The method according to any of embodiments 39-44, wherein the timing-related information applies for all cells in the master cell group.

Embodiment 46: The method according to any of embodiments 39-45, wherein the timing-related information applies only when the Carrier Aggregation (CA) is not configured or when only a limited number of carriers are supported or when a dual connectivity (DC) is not supported.

Embodiment 47: The method according to any of embodiments 39-46, wherein the timing-related information applies only for a certain carrier frequency range.

Embodiment 48: A method for enhanced time synchronization between an access node and a wireless communication device in a wireless communication network, comprising the following steps carried out at the wireless communication device: measuring the wireless communication device received timing of downlink subframe #i from a Transmission Point (TP) and the wireless communication device transmit timing of uplink subframe #j that is closest in time to the subframe #i received from the TP; and deriving the receive-transmit time difference based on the wireless communication device received timing of downlink subframe #i and the wireless communication device transmit timing of uplink subframe #j.

Embodiment 49: The method according to embodiment 48, wherein an error of the receive-transmit time difference is smaller than a predefined receive-transmit Time difference measurement accuracy.

Embodiment 50: The method according to embodiment 48 or 49, wherein the Receive-Transmit time difference measurement accuracy is a function of one or more of the following parameters:
Downlink signal SINR Ês/Iot (dB), where Ês is Received energy per RE, and Iot is the received power spectral density of the total noise and interference for a certain RE;
Downlink signal Io range, where Io is the total received power density, including signal and interference, as measured at the UE antenna connector.
Downlink signal transmission bandwidth;
Downlink signal SCS;
Uplink signal SCS;
Frequency-division duplexing vs Time-division duplexing;
Frequency Range 1 vs Frequency Range 2;
Operating band;
Operating band combination.

Embodiment 51: The method according to any of embodiments 48-50, wherein the Receive-Transmit time difference measurement accuracy applies only for Downlink delicate RRC message or the SIB9 that contains the reference timing.

Embodiment 52: The method according to any of embodiments 48-51, wherein the Receive-Transmit time difference measurement accuracy applies only during the period in which the accurate reference time may be delivered is configured to the UE.

Embodiment 53: An access node, comprising: at least one processor; and a memory containing program code executable by the at least one processor, whereby execution of the program code by the at least one processor causes the access node to perform a method according to anyone of embodiments 29-52.

Embodiment 54: A computer program product being embodied in a computer readable storage medium and comprising program code to be executed by at least one processor of an access node, whereby execution of the program code causes the access node to perform a method according to anyone of embodiments 29-52.

Those skilled in the art will recognize improvements and modifications to the embodiments of the present disclosure. All such improvements and modifications are considered within the scope of the concepts disclosed herein.

1-17. (canceled)

18. A method performed by an access node for a wireless network, the method comprising:
receiving an uplink reference signal from a User Equipment, UE;
deriving timing-related information based on the uplink reference signal in accordance with a defined uplink signal timing detection error requirement, the defined uplink signal timing detection error requirement being a function of:
a subcarrier spacing used for the uplink reference signal such that the uplink signal timing detection error requirement is inversely related to the subcarrier spacing used for the uplink reference signal; or
a total bandwidth occupied by the uplink reference signal such that the uplink signal timing detection error requirement is inversely related to the total bandwidth occupied by the uplink reference signal; or
both the subcarrier spacing used for the uplink reference signal and the total bandwidth occupied by the uplink reference signal; and
sending the timing-related information to the UE.

19. The method of claim 18 wherein the uplink reference signal is a Sounding Reference Signal, SRS.

20-35. (canceled)

36. An access node for a wireless network, the access node comprising:
one or more processors; and
memory comprising instructions executable by the one or more processors whereby the access node is operable to:
receive an uplink reference signal from a User Equipment, UE;
derive timing-related information based on the uplink reference signal in accordance with a defined uplink signal timing detection error requirement, the defined uplink signal timing detection error requirement being a function of:
a subcarrier spacing used for the uplink reference signal such that the uplink signal timing detection error requirement is inversely related to the subcarrier spacing used for the uplink reference signal; or
a total bandwidth occupied by the uplink reference signal such that the uplink signal timing detection error requirement is inversely related to the total bandwidth occupied by the uplink reference signal; or
both the subcarrier spacing used for the uplink reference signal and the total bandwidth occupied by the uplink reference signal; and
send the timing-related information to the UE.

37. (canceled)

38. A method performed by an access node for a wireless network, the method comprising:
measuring a receive timing of an uplink subframe containing an uplink signal associated with a User Equipment, UE;
measuring a transmit timing of a downlink subframe that is closest in time to the uplink subframe containing the uplink signal associated with the UE;
deriving Receive-to-Transmit, Rx-Tx, timing of the access node based on the measured receive timing and the measured transmit timing;
wherein the Rx-Tx timing is derived in accordance with a defined Rx-Tx timing accuracy requirement that is a function of:
(a) uplink signal Signal to Interference Plus Noise, SINR, Ês/lot, where Ês is Received energy per Resource Element (RE) and lot is a received power spectral density of a total noise and interference for a certain RE;
(b) uplink signal Io range, where Io is a total received power density, including signal and interference, as measured at a UE antenna connector of the UE;
(c) uplink signal transmission bandwidth;
(d) uplink signal subcarrier spacing;
(e) downlink signal subcarrier spacing;
(f) whether Frequency Division Duplexing, FDD, or Time Domain Duplexing, TDD, is used
(g) whether the access node is operating in frequency range 1, FR1, or frequency range 2, FR2;
(h) an operating band of the access node;
(i) an operating band combination being used;
(j) a configured maximum transmission power of the UE;
(k) a configured maximum transmission power of the UE on a serving cell of the UE; or
(l) any two or more of (a)-(k).

39. The method of claim 38 wherein the uplink signal is a PRACH preamble, a PUCCH signal, a PUSCH signal, a SRS, a DMRS, or a PTRS.

40. (canceled)

41. (canceled)

42. A method performed by a User Equipment, UE, comprising:
receiving a downlink signal from an access node; and
deriving timing-related information based on the downlink signal, in accordance with a downlink signal timing detection error requirement that is a function of:
a subcarrier spacing used for the downlink signal such that the downlink signal timing detection error requirement is inversely related to the subcarrier spacing used for the downlink signal; or
a total bandwidth occupied by the downlink signal such that the downlink signal timing detection error requirement is inversely related to the total bandwidth occupied by the downlink signal; or
both the subcarrier spacing used for the downlink signal and the total bandwidth occupied by the downlink signal.

43-45. (canceled)

46. A method performed by a User Equipment, UE, comprising:
transmitting an uplink signal to an access node, in accordance with an uplink signal transmit timing error requirement that initial UE transmission error is ±T_{eTSN} where T_{eTSN} is a UE transmit timing error limit value that is a function of:
a subcarrier spacing used for the uplink signal; or
a total bandwidth occupied by the uplink signal; or
both the subcarrier spacing used for the uplink signal and the total bandwidth occupied by the uplink signal.

47. The method of claim 46 wherein the uplink signal is: CSI-RS, PRS, DMRS, TRS, or any combination thereof.

48. (canceled)

49. (canceled)

50. A method performed by a User Equipment, UE, for a wireless network, the method comprising:
measuring a receive timing of a downlink subframe containing a downlink signal received from an access node;
measuring a transmit timing of an uplink subframe that is closest in time to the downlink subframe containing the downlink signal;
deriving Receive-to-Transmit, Rx-Tx, timing of the UE based on the measured receive timing and the measured transmit timing;
wherein the Rx-Tx timing is derived in accordance with a defined Rx-Tx timing accuracy requirement that is a function of:
(a) downlink signal Signal to Interference Plus Noise, SINR, Ês/lot, where Ês is Received energy per Resource Element (RE) and Iot is a received power spectral density of a total noise and interference for a certain RE;
(b) downlink signal Io range, where Io is a total received power density, including signal and interference, as measured at a UE antenna connector of the UE;
(c) downlink signal transmission bandwidth;
(d) downlink signal subcarrier spacing;
(e) uplink signal subcarrier spacing;
(f) whether Frequency Division Duplexing, FDD, or Time Domain Duplexing, TDD, is used
(g) whether the access node is operating in frequency range 1, FR1, or frequency range 2, FR2;
(h) an operating band of the UE;
(i) an operating band combination being used; or
(j) any two or more of (a)-(i).

51. (canceled)

52. (canceled)
